(19) United States
(12) Patent Application Publication
(10) Pub. No.: US 2007/0262613 A1
(43) Pub. Date: Nov. 15, 2007

(54) Cross-member configuration for a motor vehicle

(75) Inventor: Steffen Meier, Freudental (DE)

Correspondence Address: LERNER GREENBERG STEMER LLP, P O BOX 2480, HOLLYWOOD, FL, 33022-2480, US

(73) Assignee: Dr. Ing. h.c.F. Porsche AG

(21) Appl. No.: 11/800,533

(22) Filed: May 7, 2007

(30) Foreign Application Priority Data
May 5, 2006 (DE) 102006020947.8-42

(51) Int. Cl. B62D 25/08

(52) U.S. Cl. 296/192

(57) ABSTRACT

A cross-member configuration for a motor vehicle has a basic member for receiving functional elements, and a body cross-member. The basic member is fastened to the body cross-member via holding elements. The holding elements have, on the body cross-member side, a stepped connecting region which is connected to a connecting region which is configured in a complementary manner thereto on the body cross-member. In addition, it is provided that the connecting regions each have at least two stepped surfaces which bear against one another when holding elements are connected to the body cross-member.

### CROSS-REFERENCE TO RELATED APPLICATION

This application claims the priority, under 35 U.S.C. § 119, of German application DE 10 2006 020 947.8-42, filed May 5, 2006; the prior application is herewith incorporated by reference in its entirety.

### BACKGROUND OF THE INVENTION

### Field of the Invention

The present invention relates to a cross-member configuration for a motor vehicle, with a basic member for receiving functional elements, and a body cross-member, in particular a cowl, the basic member being fastened to the body cross-member via holding elements.

Cross-member configurations of this type extend transversely with respect to the longitudinal axis of the vehicle, for example between two lateral edge regions, in particular between the two front A-pillars. Functional elements, such as, for example, a steering column and holders for further instruments, in particular an instrument panel, are fastened to the cross-member configuration. In this case, a basic member is usually supported on a body cross-member, for example a cowl, below the windshield. In order to be able to provide the required rigidity, usually “brackets” or “struts” are used, but these are complicated and expensive and, furthermore, frequently have considerable weight.

Published, non-prosecuted German patent application DE 102 36 524 A1 discloses a cross-member configuration for a vehicle, with at least part of a basic member being held such that it is strong in tension. By this, the actually contradictory requirements namely the reduction of the high weight with, at the same time, sufficient rigidity, are to be met.

German Utility Model DE 200 08 201 U1 discloses an instrument panel member of hybrid construction for incorporation between the A-pillars of a motor vehicle. In this case, the instrument panel member has an elongate, shell-like basic body and stabilizing inserts of metallic materials, which are joined by an inner plastic ribbed structure injection molded on to them to form a metal/plastic composite.

Finally, published, non-prosecuted German patent application DE 198 30 303 A1 (corresponding to U.S. Pat. No. 6,325,440), published, non-prosecuted German patent application DE 102 14 473 A1, published, European patent application EP 1 136 345 A1 (corresponding to U.S. Pat. No. 6,433,633), German Utility Model DE 203 08 895 U1, published, non-prosecuted German patent application DE 100 25 981 A1 (corresponding to U.S. Pat. No. 6,478,333), international patent disclosure WO 03/031746 A2 (corresponding to U.S. patent publication No. 6,433,633), U.S. Pat. No. 6,827,393 B2, U.S. patent publication No. 2005/013409 A1 and U.S. patent publication No. 2002/0105204 A1 disclose further cross-members for motor vehicles.

### SUMMARY OF THE INVENTION

It is accordingly an object of the invention to provide a cross-member configuration for a motor vehicle which overcomes the herein-mentioned disadvantages of the heretofore-known devices of this general type, which provides an improved cross-member configuration.

With the foregoing and other objects in view there is provided, in accordance with the invention, a cross-member configuration for a motor vehicle. The cross-member configuration contains a body cross-member having a connecting region and holding elements each having a stepped connecting region on a body cross-member side. The stepped connecting region is configured complementary to the connecting region and is connected to the connecting region on the body cross-member. The connecting region and the stepped connecting region each have at least two stepped surfaces bearing against one another. A basic member for receiving functional elements is fastened to the body cross-member by the holding elements.

The invention is based on the general concept of connecting a basic member of a cross-member configuration to a stepped, in particular, double-section connecting region in the body cross-member via holding elements. The basic member here serves to receive functional elements while the body cross-member is configured, for example, as a cowl. For, on the one hand easy, and, on the other hand stiff connection of the basic member to the body cross-member, connecting regions, which are each stepped on the body cross-member side, are provided on the holding elements disposed between the two members. The connecting regions are connected to a connecting region which is configured in a complementary manner thereto on the body cross-member. The stepped connecting regions each have at least two stepped surfaces which bear against one another. Via the stepped connection between the holding elements in the body cross-member, a particularly torsion-resistant connection between the two is achieved, as a result of which an instrument panel disposed on the basic member is also held stiffly on the body cross-member. Furthermore, the connection, which is of double-section construction, facilitates the installation of the basic member with the holding elements disposed thereon on the body cross-member, and therefore a reduction of the installation costs and installation time can also be obtained. Furthermore, the holding elements configured in such a manner have a comparatively low weight thus enabling the overall weight of the motor vehicle equipped with the cross-member configuration according to the invention to be reduced and, as a result, a positive effect on the energy balance of the vehicle can be obtained.

In a preferred development of the solution according to the invention, two holding elements are connected to each other in the transverse direction of the vehicle via a connecting bracket. This effects a stiffening of the two holding elements in the transverse direction of the vehicle and, as a result, an improved, since stiffer, connection of the basic member to the body cross-member. Furthermore, it can be provided that the connecting bracket has recesses which are configured in a complementary manner to the outer contour of the basic member and in which the basic member engages with a form fit. A recess of this type may be, for example, a groove or a receptacle which at least partially surrounds or embraces the basic member and, as a result, reliably connects the latter to the holding element. In addition thereto, the basic member can be welded, soldered or adhesively bonded to the holding element.

The basic member is expediently fastened to the longitudinal center tunnel of the motor vehicle via a strut. By this measure the basic member is supported on an additional body part, this results in a particularly stiff and reliable connection between the basic member and the motor vehicle body.

It goes without saying that the features mentioned above and the features yet to be explained below can be used not only in the combination provided in each case but also in other combinations or on their own without departing from the scope of the present invention.

Other features which are considered as characteristic for the invention are set forth in the appended claims.

Although the invention is illustrated and described herein as embodied in a cross-member configuration for a motor vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings. Preferred exemplary embodiments of the invention are explained in more detail in the description below, with the same reference numbers relating to identical or similar or functionally identical components.

### BRIEF DESCRIPTION OF THE DRAWINGS

FIG. 1 is a diagrammatic, perspective view of a cross-member configuration according to the invention;

FIG. 2 is a diagrammatic, exploded perspective view of a basic member with holding elements; and

FIG. 3 is a diagrammatic, cross-sectional view of a holding element.

### DESCRIPTION OF THE PREFERRED EMBODIMENTS

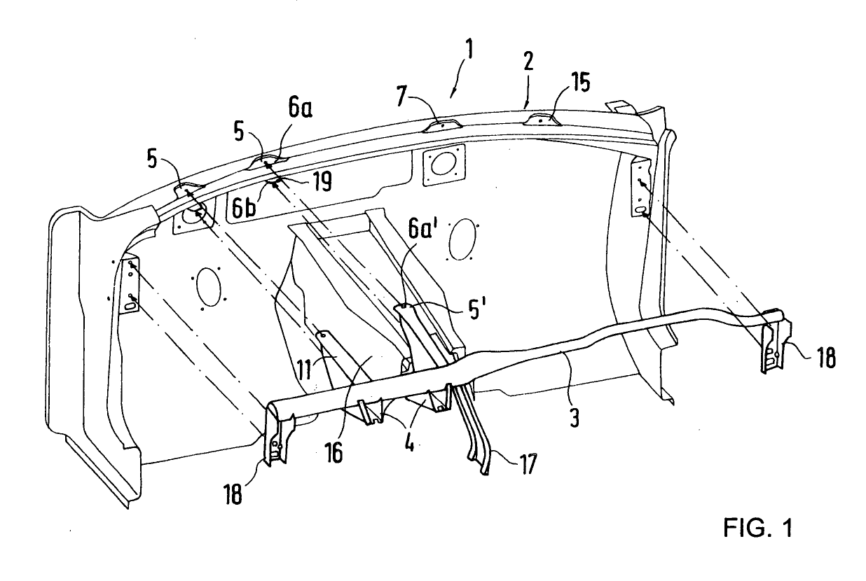

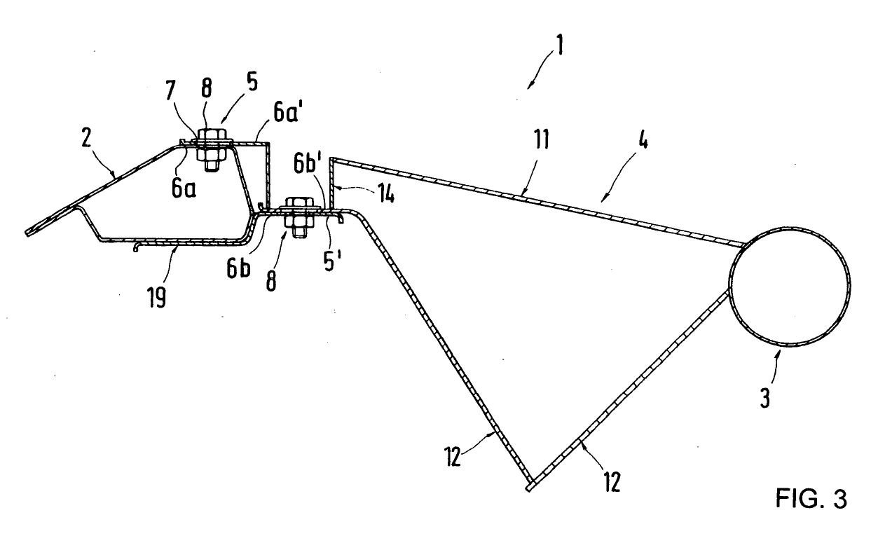

Referring now to the figures of the drawing in detail and first, particularly, to FIG. 1 thereof, there is shown a motor vehicle (only partially illustrated) that has a cross-member configuration 1 with a body cross-member 2, a basic member 3 and holding elements 4. The basic member 3 is configured here to receive non-illustrated functional elements, such as, for example, an instrument panel. The body cross-member 2, which belongs to the cross-member configuration 1, forms, according to FIG. 1, a cowl below a non-illustrated windshield and runs substantially transversely with respect to the longitudinal direction of the vehicle between two non-illustrated A-pillars of the motor vehicle. Furthermore, the basic member 3 is fastened to the body cross-member 2 via the holding elements 4, to be precise via a double-section connection in each case. To produce the double-section connection, the holding elements 4 each have, on the body cross-member side, a stepped connecting region 5′ (see FIG. 3) which is connected to a connecting region 5 which is configured in a complementary manner thereto on the body cross-member 2. In this case, both the connecting regions 5′ on the holding elements 4 and the connecting regions 5 on the body cross-member 2 each have at least two stepped surfaces 6a, 6b, 6a′, 6b′ as illustrated in particular in FIG. 3. When the cross-member configuration 1 is fully fitted, the respective stepped surfaces 6a′, 6b′ of the holding elements 4 bear against the associated stepped surfaces 6a, 6b, of the body cross-member 2.

In order to ensure a reliable connection between the holding elements 4 and therefore the basic member 3 and the body cross-member 2, passage openings 7 are provided in the respective stepped surfaces 6a, 6b, 6a′, 6b′ of the holding elements 4 and of the body cross-member 2, which passage openings are aligned with one another when the holding elements 4 are connected to the body cross-member 2, to be precise in such a manner that connecting devices 8, for example screws, can be plugged through the aligned passage openings 7 (see FIG. 3).

As FIG. 1 furthermore shows, the two holding elements 4 illustrated by way of example are connected to each other in the transverse direction of the vehicle via a connecting bracket 9, the connecting bracket 9 having, on the basic member side, recesses 10 which are preferably configured in a complementary manner to the outer contour of the basic member 3. The recesses 10 which are configured in such a manner permit the basic member 3 to engage in the recesses 10 with a form fit. In this case, the basic member 3 is preferably at least partially embraced by the recesses 10 of the holding elements 4 such that a reliable and positionally fixed mounting of the basic member 3 in the recesses 10 is ensured. In addition, it can be provided that the holding elements 4 are connected to the basic member 3 in some other way, in particular are adhesively bonded, soldered or welded thereto.

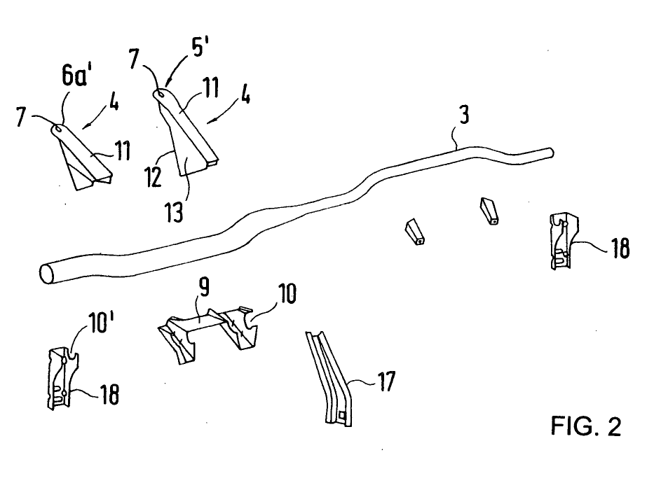

According to FIG. 3, the holding element 4, which is illustrated in cross section, has a top cord 11, a bottom cord 12 and a stiffening element 13, which is illustrated in FIG. 2. In this case, the stiffening element 13 is arranged between the top cord and the bottom cord 12 and stiffens them in relation to each other. In this connection, it is particularly advantageous that the holding elements 4 are composed of a plurality of individual components and, as a result, particularly light holding elements 4 can be provided. In particular, it is possible to configure the top cord 11 and/or the bottom cord 12 as strip-shaped cords which are connected stiffly to each other via a, for example, double-walled stiffening element 13. The holding elements 4 assembled in such a manner have a high degree of flexural rigidity in the main directions of loading while being of low weight.

As FIG. 3 furthermore shows, the top cord 11 forms a first stepped surface 6a′ on the body cross-member side, and the bottom cord 12 forms a second stepped surface 6b′ likewise on the body cross-member side. In order to be able to introduce the connecting device 8 into the passage opening 7 of the second stepped surface 6b′, a sleeve element 14 is disposed between the top cord 11 and the bottom cord 12 and is aligned with the passage opening 7 in the second stepped surface 6b′.

In order to connect the second stepped surface 6b′ of the connecting region 5′ of the holding element 4 to the body cross-member 2, tab elements 19 are disposed on the body cross-member 2 and form the stepped surface 6b of the connecting region 5 on the body cross-member side. The tab elements 19 can be connected to the body cross-member 2 in a suitable manner, in particular by adhesive bonding, soldering or welding.

According to FIG. 1, depressions 15 can be seen on the body cross-member 2, in which depressions a step 6a′ of the connecting region 5′ of the respective holding element 4 engages in each case in such a manner that a recessed configuration of the step 6a′ in the depression 15 is produced. In this case, the depression 15 additionally serves as an installation aid which facilitates exact positioning of the holding element 4 or of the respective step 6b, 6b′ of the connecting region 5′ on the body cross-member 2. The depression 15 is preferably matched to the overall height of the top cord 11 or the step 6a′ in such a manner that, when the top cord 11 is inserted into the depression 15, an aligned, i.e. continuous surface is produced.

In addition to the fastening of the basic member 3 to the body cross-member 2 via the holding elements 4, further fastenings are provided on a center tunnel 16 (see FIG. 1) and on a longitudinal end region of the basic member 3. The fastening of the basic member 3 to the longitudinal center tunnel 16 of the motor vehicle takes place via a strut 17 (see FIG. 2) which preferably is welded or soldered to the basic member 3 and is screwed to the longitudinal center tunnel 16. The longitudinal end side fastening of the basic member 3 to a non-illustrated A-pillar of the motor vehicle can take place either directly or indirectly via a respective bracket 18. Like the holding elements 4, the bracket 18 has a recess 10′ which is of complementary construction to the outer contour of the basic member 3 and in which the basic member 3 engages preferably with a form fit. It is also conceivable here for the bracket 18 to be connected to the basic member 3 in some other way, in particular to be adhesively bonded, soldered or welded thereto.

In order to be able to take into account individual requirements of the types of vehicle with regard to the configuration of the interior, the basic member 3 is configured as a supporting tube which is curved in some regions, and, as a result, permits a gain in space for vehicle occupants. Since loads of differing magnitude also have to be absorbed in the region of the longitudinal extent of the basic member 3, for example, in the region of a steering column, the basic member 3 has a cross section varying in the longitudinal direction (see FIG. 2), as a result of which it takes into account, for example, different flexural loads.

The holding elements 4 and the struts 17 and the brackets 18 or the tab elements 19 are preferably configured as sheet-metal molded parts which can be produced in a simple and cost-effective manner and at the same time have a low weight, which has a positive effect on the energy balance of the vehicle.

I claim:

1. A cross-member configuration for a motor vehicle, the cross-member configuration comprising:
a body cross-member having a connecting region;
holding elements each having a stepped connecting region on a body cross-member side, said stepped connecting region being configured complementary to said connecting region and connected to said connecting region on said body cross-member, said connecting region and said stepped connecting region each having at least two stepped surfaces bearing against one another; and
a basic member for receiving functional elements and fastened to said body cross-member by said holding elements.

2. The cross-member configuration according to claim 1, wherein at least one of said stepped surfaces of said holding elements and of said body cross-member each have a respective passage opening formed therein, said passage openings being aligned with one another when said holding elements are connected to said body cross-member.

3. The cross-member configuration according to claim 1, further comprising a connecting bracket, two of said holding elements are connected to each other in a transverse direction of the motor vehicle via said connecting bracket.

4. The cross-member configuration according to claim 2, wherein said holding elements each have a top cord and a bottom cord and a stiffening element which is disposed between said top cord and said bottom cord.

5. The cross-member configuration according to claim 1, wherein:
said stepped connecting region has a step; and
said body cross-member has depressions formed therein in which said step of said stepped connecting region of said respective holding element engages in each case such that a recessed configuration is produced, and said holding elements are welded to said basic member.

6. The cross-member configuration according to claim 1, further comprising a strut, said basic member being fastened to a longitudinal center tunnel of the motor vehicle via said strut.

7. The cross-member configuration according to claim 1, wherein said basic member is a supporting tube curved in some regions.

8. The cross-member configuration according to claim 1, further comprising a bracket connected to said basic member, said basic member fastened on a longitudinal end side via said bracket directly, or indirectly via a mating bracket, to an A-pillar of the motor vehicle.

9. The cross-member configuration according to claim 1, further comprising tab elements disposed on said body cross-member and form one of said stepped surfaces of said connecting region on said body cross-member side.

10. The cross-member configuration according to claim 1, wherein said body cross-member is a cowl.

11. The cross-member configuration according to claim 2, wherein said holding elements are screwed to said body cross-member through said passage openings.

12. The cross-member configuration according to claim 3, wherein said connecting bracket has recesses formed therein and configured in a complementary manner to an outer contour of said basic member and in said recesses said basic member engages with a form fit.

13. The cross-member configuration according to claim 4, wherein said top cord forms a first stepped surface and said bottom cord forms a second stepped surface.

14. The cross-member configuration according to claim 13, wherein said holding elements each have a sleeve element disposed on said body cross-member side between said top cord and said bottom cord and is substantially aligned with said passage opening in said second stepped surface.

15. The cross-member configuration according to claim 1, wherein said basic member has a cross section varying in a longitudinal direction.

16. The cross-member configuration according to claim 8, wherein said bracket has a recess formed therein and is of complementary design to an outer contour of said basic member and in which said basic member engages with a form fit.

17. A motor vehicle, comprising:
a cross-member configuration, said cross-member configuration including:
a body cross-member having a connecting region;
holding elements each having a stepped connecting region on a body cross-member side, said stepped connecting region being configured complementary to said connecting region and connected to said connecting region on said body cross-member, said connecting region and said stepped connecting region each having at least two stepped surfaces bearing against one another; and
a basic member for receiving functional elements and fastened to said body cross-member by said holding elements.
